(19) United States
(12) Patent Application Publication
(10) Pub. No.: US 2012/0102229 A1
(43) Pub. Date: Apr. 26, 2012

(54) COMMUNICATIONS NETWORK

(75) Inventor: Ernst Von Weyhausen, Road Town (VG)

(73) Assignee: Allmyflights Limited, Road Town (VG)

(21) Appl. No.: 12/908,851

(22) Filed: Oct. 20, 2010

(51) Int. Cl. G06F 15/16

(52) U.S. Cl. 709/246

(57) ABSTRACT

A communications network for a travel information system is disclosed including a server 12, user appliances 2a, 2b, and travel operator servers 3a, 3b. The user appliances 2a, 2b are arranged to submit travel information requests to the server 12 which in turn submits requests to the relevant travel operator servers 3a, 3b. The travel operator servers 3a, 3b return formatted data to the server 12. The formatted data are clipped by the server 12 and forwarded to the user computers 2a, 2b together with an extraction tool so that a processing unit 30 in the user computer 2 can apply the extraction tool to extract relevant travel information from the formatted data.

The present invention relates to a communications network. More specifically the invention relates to a communications network for a travel information service.

Travel information services provided over the internet typically include a central server that provides travel information in response to requests from user computers. The central server maintains a database including the travel information, and this database is populated with information that is derived from travel operators' web services. The travel information typically includes schedules and prices for a large number of different travel operators.

The central server database typically has a large data capacity because a large number of travel products can exist, and each product can have many different permutations. In order to update information in the database the central server needs to communicate with a number of travel operator web services. The task of maintaining and updating the database can be burdensome for the central server.

A further burden can be placed on the central server because of the high frequency with which travel operators change the properties of their products. Prices, in particular, can be changed with such frequency that any given price is only considered valid for around five minutes. Thus, all products stored in the database must be constantly refreshed if they are to remain valid. In order to refresh a product the central server typically downloads relevant data from a travel operator web server and then extracts updated product information from the downloaded data. This places a heavy load on the central server.

An object of the present invention is to reduce the demands on the central server of a travel information system. In this way it may be possible to provide a central server with a reduced capacity for data storage and/or processing.

According to an aspect of the present invention there is provided an apparatus comprising: a data reception module arranged to receive formatted data from a third party; a data storage unit arranged to store at least one extraction tool that is configured to extract information from formatted data; and a delivery module arranged to deliver formatted data and an extraction tool to a user computer so that the user computer can use the extraction tool to extract information from the formatted data set.

In this way a server computer does not need to continually update an information database. The server can reduce its processing burden by requesting information only when it is required, and delegating information extraction to user computers. The extraction tools can be used to extract information of interest from a variety of formatted data types.

This may be particularly useful in travel information services which conventionally require a central server with considerable data processing and data storage capacity. The delegation of information extraction to user computers can allow travel information services to be operated by a central server having reduced processing and data storage facilities,

Preferably the data reception module is arranged to receive extracted information from user computers and to store the extracted information in the data storage unit. Thus, the user computers can extract relevant information using the extraction tool, and upload this information to the server computer. By storing the extracted information in the data storage unit the server computer can re-issue this information to other user computers if it is required while the information remains valid. This is advantageous because it means that information extraction only needs to be performed once within a validity period by a single user computer. Other user computers can benefit from this extraction by downloading the extracted information directly from the server computer so that the information can be displayed on the user computer. A further advantage is that the relevant data only needs to be requested once in a validity period from a third party, which may be a travel information server. This desirably reduces the demand on third party servers and also reduces traffic over the network.

The data storage unit may be configured to store extracted information together with an indication of the time at which the information was extracted. An associated time stamp can be a useful indication of the validity of the stored information. In one embodiment the validity period for stored information is five minutes.

When information is supplied to a user directly from the data storage unit of a central server it is preferable for the central server to also include the indication of the time at which the information was extracted. In this way the user computer can display the information along with a time stamp so that a user can determine how current the information is, and therefore the extent to which it can be trusted.

The apparatus may further comprise an interface module that is configured to request formatted data from a third party when the relevant extracted information is not stored in the storage unit. The server may receive requests for information from user computers. If the relevant information has already been extracted, and is stored in the data storage unit, it may be delivered directly to the user computers. However, if the relevant information is absent the interface module may request new formatted data from a third party such as a travel operator web service.

Preferably the interface module is configured to request formatted data from a third party when the relevant extracted information is stored in the storage unit, and the time that has elapsed since the relevant information was extracted is greater than a predetermined value such as around five minutes.

The apparatus may further comprise a clipping module that is arranged to clip the received formatted data before it is delivered to a user computer by the delivery module. In this way it is possible to reduce network traffic. Typically formatted data sets include relevant information and extraneous matter. For example, the formatted data set may be HTML from a flight operator that includes flight information and advertisements. In this example the advertisements may be considered extraneous and they may be excluded from the formatted data by the clipping module.

The clipping module may increase the processing demands on the central server. However, this increase in processing demands may be tolerated in view of the beneficial effect of decreasing network traffic. In some embodiments the benefits of the clipping module may be outweighed by its disadvantages in which case the clipping module may be omitted.

The formatted data and the extraction tool may be packaged in a single container and delivered to a user computer by the delivery module. Preferably the extraction tool is appended to the formatted data. Thus, the formatted data may be considered to be a repository of information, and the extraction tool may be considered to be instructions on how to extract information. By packaging the extraction tool and formatted data in a single container a user computer can easily apply the correct extraction tool to the appropriate formatted data.

The data storage unit may be arranged to store a plurality of extraction tools and each extraction tool may be configured to extract information from a predetermined type of formatted data. The formatted data may have a variety of properties, depending on the data source. For example flight information can be received at the data reception module in HTML, JSON, text, or any other suitable file type. In addition, each different file type can be formatted in a variety of ways. An extraction tool can be designed for each expected type of formatted data so that the tool can extract the relevant information when it is run on a user computer.

The extraction tool is preferably arranged to extract and filter information from the formatted data set. In one embodiment the extracted information includes a matrix representing different times and prices for a travel product. For example, a three-dimensional matrix may represent outward travel times, return travel times, and different pricing options that are available on particular dates for a particular route. The extraction tool may be arranged to filter (or normalize) the matrix so that it includes a single pricing option; in some embodiments the filtered pricing option is the cheapest and in other embodiments the filtered pricing option is that which best matches the user's requirements. Thus, the extraction tool can convert a three-dimensional matrix into a two-dimensional matrix in which there is a single pricing option at each of the plurality of outward and return travel times; details of the single pricing option can also be identified for the user (for example, whether the pricing option is standard, business or first class). In this way, the extraction tool can desirably shift the filtering information from the central server to a user computer.

The extraction tool may also be arranged to perform a currency conversion on any financial values in the extracted information. Thus, currency conversion calculations can be performed by a user computer rather than a central server, further alleviating the processing burden on the central server.

According to another aspect of the invention there is provided a travel information system such as a flight information system comprising a data reception module arranged to receive formatted data from travel information services; a data storage unit arranged to store at least one extraction tool that is configured to extract travel information from the formatted data; and a delivery module arranged to deliver a formatted data set and the extraction tool to a user computer so that the user computer can use the extraction tool to extract travel information from the formatted data.

According to another aspect of the invention there is provided a method comprising the steps of: receiving formatted data from a third party; storing at least one extraction tool that is configured to extract information from the formatted data; and delivering formatted data and an extraction tool to a user computer so that the user computer can use the extraction tool to extract information from the formatted data.

According to yet another aspect of the invention there is provided a user electronic appliance comprising: a requester module arranged to request information from a server appliance; a data reception module arranged to receive formatted data and an extraction tool; a processing unit arranged to apply the extraction tool to extract information from the formatted data set; and an upload module arranged to upload the extracted information to the server appliance.

According to yet another aspect of the invention there is provided a communications network comprising: a server appliance; and a user appliance; wherein the server appliance comprises: a data reception module arranged to receive formatted data from a third party; a data storage unit arranged to store at least one extraction tool that is configured to extract information from formatted data; and a delivery module arranged to deliver formatted data and an extraction tool to a user computer; and wherein the user appliance comprises: a requester module arranged to request information from the server appliance; a data reception module arranged to receive formatted data and an extraction tool from the server appliance; a processing unit arranged to apply the extraction tool to extract information from the formatted data set; and an upload module arranged to upload the extracted information to the server appliance.

According to yet another aspect of the present invention there is provided a computer readable storage medium having a computer program stored thereon, the computer program comprising: a program module configured to receive formatted data from a third party; an extraction tool program module configured to extract information from a formatted data set; and a program module configured to deliver formatted data and the extraction tool program module to a user computer so that the user computer can use the extraction tool program module to extract information from the formatted data set.

Any apparatus features may be provided as method features and vice-versa.

Preferred features of the present invention will now be described, purely by way of example, with reference to the accompanying drawings, in which:

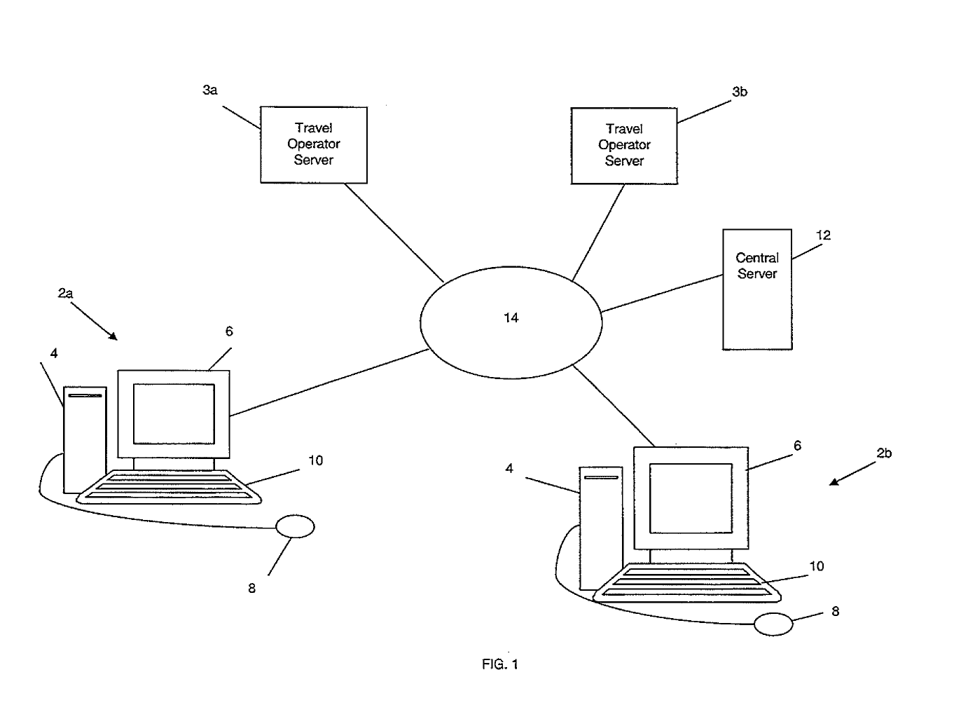

FIG. 1 is a schematic drawing of various appliances communicating over a network;

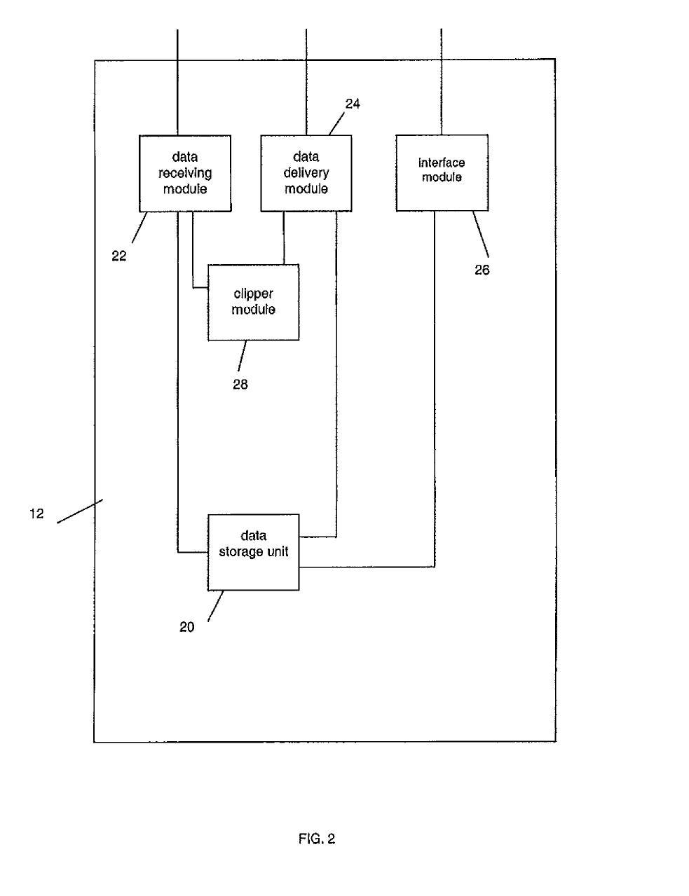

FIG. 2 shows functional blocks of a server computer in an embodiment of the invention;

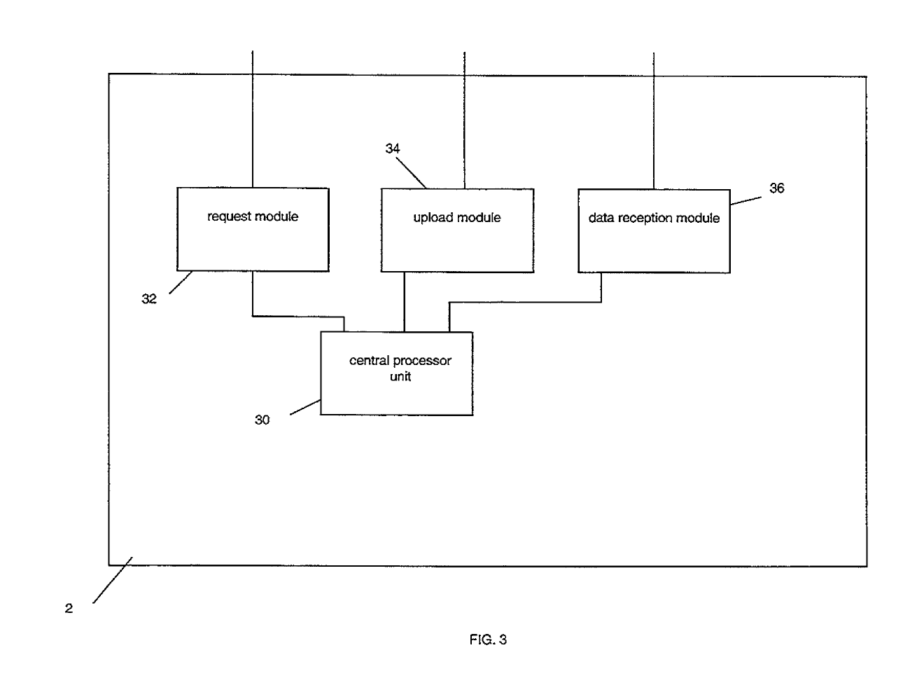

FIG. 3 shows functional blocks of a user computer in an embodiment of the invention; and

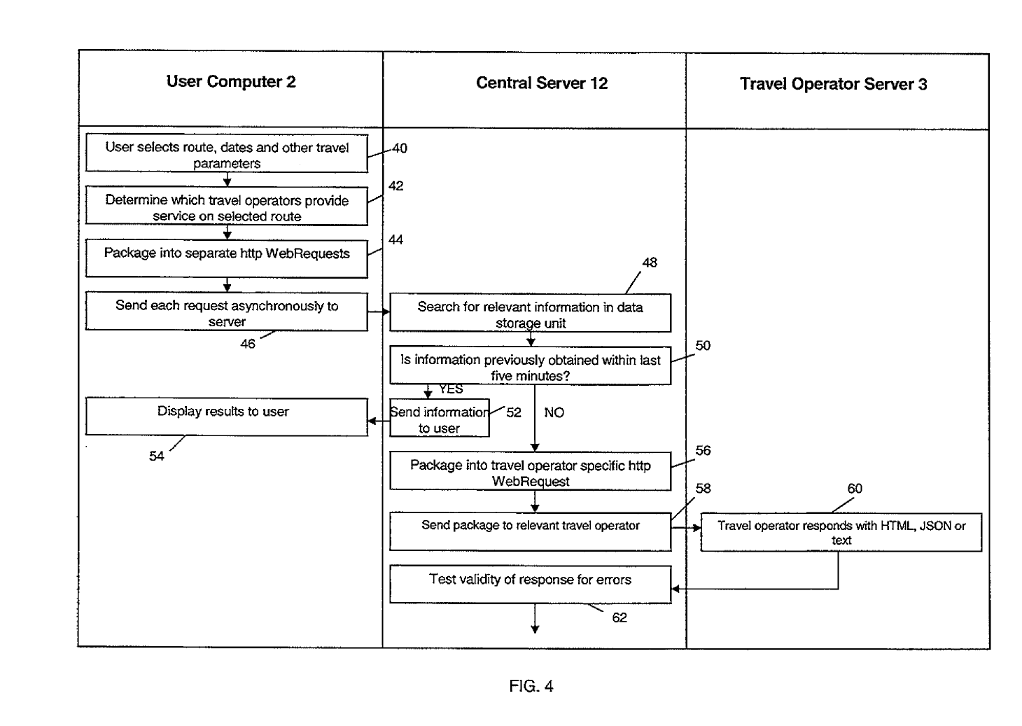

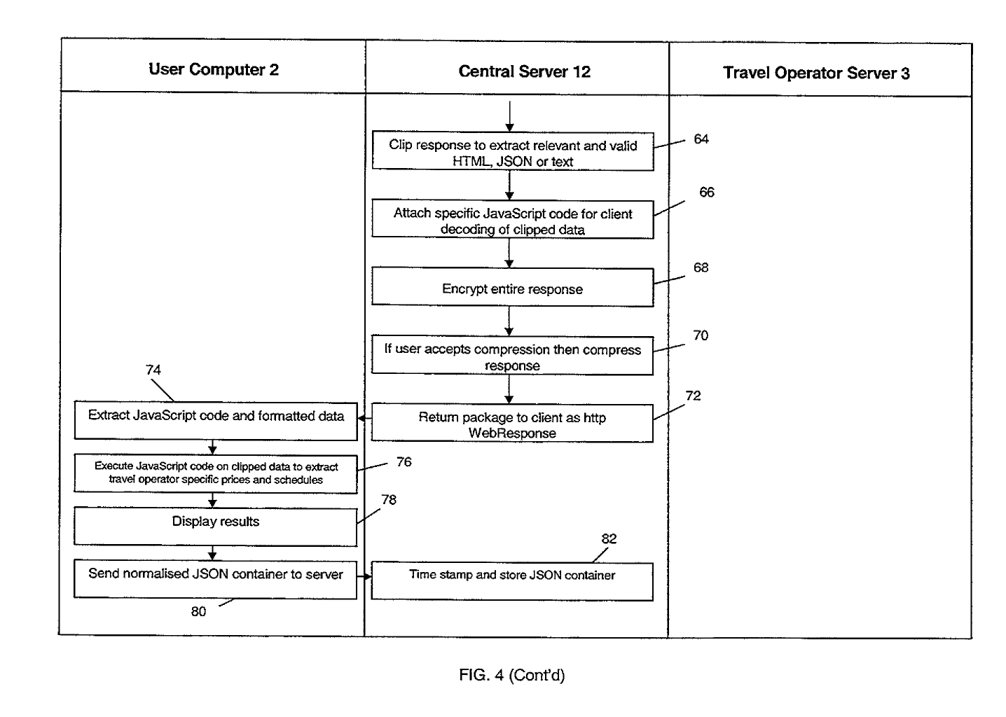

FIG. 4 is a flow diagram showing a sequence of steps that may be undertaken in an embodiment of the invention.

### DETAILED DESCRIPTION OF AN EMBODIMENT OF THE INVENTION

FIG. 1 is a schematic diagram showing user computers 2a, 2b communicating with a central server 12 over a network 14. Travel operator servers 3a, 3b are also arranged to communicate with the central server 12 over the network 14. The user computers 2a, 2b include a control unit 4, a visual display unit 6, a mouse 8, and a keyboard 10.

The central server 12 supports a travel information website that can be accessed by any of the user computers 2a, 2b. The user computers 2a, 2b can submit travel information requests to the central server 12 via the website and the central server 12 can respond with travel information as stored in a data storage unit 20. The travel information in the data storage unit 20 of the central server is populated by information received from the travel operator servers 3a, 3b.

FIG. 2 shows the functional components of the central server 12. The central server includes a data storage unit 20 that is arranged to store travel information as well as extraction tools. The extraction tools are JavaScript program modules that can operate on formatted data files in order to extract travel information, filter travel information and perform other processing operations such as currency conversions.

The data storage unit 20 is connected to a data receiving module 22, a data delivery module 24, and a interface module 26, each of which are connected to the network 14. A clipper module 28 is optionally connected between the data receiving module 22 and the data delivery module 24.

The interface module 26 is arranged to receive information requests from user computers 2a, 2b, and to transmit data requests to travel operator servers 3a, 3b. The data receiving module 22 is arranged to receive data from the travel operator servers 3a, 3b in response to requests from the interface module 26. The data received from the travel operator servers 3a, 3b are formatted using a technique that is usually specific to each source.

The data delivery module 24 is arranged to forward any requested formatted data to the relevant user appliance 2. The data delivery module 24 also retrieves an extraction tool from the data storage unit 20 and forwards this to the user appliance 2. The retrieved extraction tool is appropriate for the formatted data set so that the user appliance can apply the extraction tool to extract information from the formatted data. The data delivery module 24 packages the formatted data and the extraction tool together so that the user appliance knows to which formatted data the extraction tool is applied.

The clipper module 28 is arranged to edit formatted data sets that are received at the data receiving module 22. In particular the clipper module 28 is arranged to delete any extraneous matter from the formatted data set so that network traffic can be reduced.

FIG. 3 shows the functional components of a user computer 2. The user computer 2 includes a central processor unit 30 with respective connections to a requester module 32, an upload module 34, and a data reception module 36. The requester module 32, upload module 34 and data reception module 36 are connected to the network 14.

The requester module 32 is arranged to submit requests to the central server 12. In this way the user can request travel information on particular dates and on a particular route.

The data reception module 36 can receive travel information from the data storage unit 20 of the central server. Alternatively the data reception module 36 can receive formatted data together with an extraction tool.

The central processor 30 is arranged to extract travel information from formatted data using the received extraction tool. The received extraction tool can also be used to perform other operations on the formatted data set; for example, to filter out unnecessary information and perform currency conversions. Once the relevant information has been extracted it can be uploaded, via the upload module 34, for storage in the data storage unit 20 of the central server 12. The upload module 34 preferably uploads unfiltered information so that this is available to other users, if required.

FIG. 4 shows a flow diagram illustrating an operation of the central server 12, travel operator servers 3a, 3b and user computers 2a, 2b in an embodiment of the invention. The flow diagram is arranged to show whether a particular step is performed on the central server 12, the user computers 2a, 2b or the travel operator servers 3a, 3b.

At step 40 the user enters the parameters of the travel information they require including details of a route. The user can also enter a preferred pricing option for their travel such as standard class, business class or first class. This can be achieved by entering details in fields of a website. At step 42 the central processor unit 30 of the user computer 2 determines which travel operators perform the required route.

In this preferred embodiment the information about the routes performed by travel operators is stored in local memory (not shown), which may be random access memory (RAM). Of course, in an alternative embodiment this information could be stored in the data storage unit 20 of the central server 12.

At step 44 the requester module 32 in the user computer 2 prepares a plurality of separate information requests, one for each of the travel operators that perform the required route. The requester module 32 sends each request to the central server 12 at step 46.

The central server 12 analyses each request from the requester module 32 in parallel. At step 48 interface module 26 is arranged to search for relevant information in the data storage unit 20. Specifically, the interface module 26 examines the data storage unit 20 to find information about travel for a specific operator on specific dates and on a specific route.

When relevant information is found in the data storage unit the interface module 26 assesses at step 50 whether the information is valid (in this embodiment valid information is that which has obtained within the last five minutes). If the information is valid then, at step 52, the interface module 26 sends the relevant information to the user computer 2. The information is received at the data reception module 36 of the user computer 2 at step 54 and the results are displayed on the screen 6.

If, at steps 48 and 50, the interface module 26 determines that the relevant information is absent from the data storage unit or that it is present but invalid, the interface module 26 packages the user's request at step 56 into a travel operator specific request. In other words, the interface module 26 packages the user's request into a format that will be understood by the relevant travel operator server 3. At step 58 the interface module 26 sends the travel operator specific request to the relevant travel operator server 3.

The travel operator server 3 receives a request from the central server 12 and responds at step 60 with formatted data. Each travel operator 3 typically responds with HTML, JSON or text that has a unique format. This response is received by the central sever data receiving module 22. At step 62 the data receiving module 22 checks the validity of the response for any errors.

At step 64 the clipper module 28 clips the formatted data that is received at the data receiving module 22 in order to delete extraneous matter. Typically formatted data from a travel operator server 3 includes information of interest and some extraneous matter such as adverts and the like. The clipper module 28 is arranged to identify and delete extraneous matter.

At step 66 the data delivery module 24 is arranged to retrieve an extraction tool from the data storage unit 20 that is appropriate for the formatted data. The extraction tool is actually JavaScript code that can be run on a user computer 2 in order to enable the user computer 2 to extract relevant information from the formatted data and perform other processing steps on the information. The data delivery module 24 is configured to attach the extraction tool to the formatted data by appending it to the beginning of the file.

At step 68 the data delivery module 24 is arranged to encrypt the package that includes the formatted data and the extraction tool, and at step 70 the package can be compressed. The package is finally returned to the user computer by the data delivery module 24 at step 72. The user computer receives the package at the data reception module 36.

The central processor 30 in the user computer 2 recovers the extraction tool and the formatted data at step 74 using decryption and decompression techniques, as appropriate. The central processor 30 runs the extraction tool at step 76 in order to extract relevant travel information from the formatted data.

The running of the extraction tool at step 76 also involves filtering the information to exclude information that is not relevant. In one embodiment formatted data from a travel operator server 3 can include a plurality of pricing options for a particular route and date; pricing options may include standard class, first class, business class and other variants. The extraction tool is arranged to extract information for all of the pricing options, but to filter out all but a single pricing option for display to the user. The extraction tool is arranged to select the pricing option that best matches the user's requirements as entered at step 40, and to convert any prices to an appropriate currency.

The travel information for a particular travel operator is displayed to the user at step 78. Of course, the procedure shown in FIG. 4 is performed in parallel for each of the relevant travel operators and a full set of results including travel information for all of the relevant operators can be displayed to the user in any convenient format.

At step 80 the upload module 34 is arranged to upload any extracted information to the central server 12. The central server receives uploaded information at the interface module 26 at step 82 and stores this information in the data storage unit 20. The interface module 26 also creates a time stamp file and associates it with the extracted information.

1. An apparatus comprising:
a data reception module arranged to receive formatted data from a third party;
a data storage unit arranged to store at least one extraction tool that is configured to extract information from formatted data; and
a delivery module arranged to deliver formatted data and an extraction tool to a user computer so that the user computer can use the extraction tool to extract information from the formatted data set.

2. The apparatus of claim 1 wherein the data reception module is arranged to receive extracted information from user computers and to store the extracted information in the data storage unit.

3. The apparatus of claim 1 wherein the data storage unit is configured to store extracted information together with an indication of the time at which the information was extracted.

4. The apparatus of claim 3 further comprising a interface module that is configured to request formatted data from a third party when the relevant extracted information is not stored in the storage unit.

5. The apparatus of claim 4 wherein the interface module is configured to request formatted data from a third party when the relevant extracted information is stored in the storage unit, and the time that has elapsed since the relevant information was extracted is greater than a predetermined value.

6. The apparatus of claim 1 further comprising a clipping module that is arranged to clip the received formatted data before it is delivered to a user computer by the delivery module.

7. The apparatus of claim 1 wherein the formatted data and the extraction tool are packaged in a single container and delivered to a user computer by the delivery module.

8. The apparatus of claim 1 wherein the data storage unit is arranged to store a plurality of extraction tools and each extraction tool is configured to extract information from a predetermined type of formatted data.

9. The apparatus of claim 1 wherein the extraction tool is configured to extract and filter information from formatted data.

10. A travel information system comprising
a data reception module arranged to receive formatted data from travel information services;
a data storage unit arranged to store at least one extraction tool that is configured to extract travel information from the formatted data; and
a delivery module arranged to deliver a formatted data set and the extraction tool to a user computer so that the user computer can use the extraction tool to extract travel information from the formatted data.

11. A method comprising the steps of:
receiving formatted data from a third party;
storing at least one extraction tool that is configured to extract information from the formatted data; and
delivering formatted data and an extraction tool to a user computer so that the user computer can use the extraction tool to extract information from the formatted data.

12. A user electronic appliance comprising:
a requester module arranged to request information from a server appliance;
a data reception module arranged to receive formatted data and an extraction tool;
a processing unit arranged to apply the extraction tool to extract information from the formatted data set; and
an upload module arranged to upload the extracted information to the server appliance.

13. A communications network comprising:
a server appliance; and
a user appliance;
wherein the server appliance comprises:
a data reception module arranged to receive formatted data from a third party;
a data storage unit arranged to store at least one extraction tool that is configured to extract information from formatted data; and
a delivery module arranged to deliver formatted data and an extraction tool to a user computer;
and wherein the user appliance comprises:
a requester module arranged to request information from the server appliance;
a data reception module arranged to receive formatted data and an extraction tool from the server appliance;
a processing unit arranged to apply the extraction tool to extract information from the formatted data set; and
an upload module arranged to upload the extracted information to the server appliance.
